(19) United States
(12) Patent Application Publication
(10) Pub. No.: US 2012/0275968 A1
(43) Pub. Date: Nov. 1, 2012

(54) TEMPERATURE INDICATING COMPOSITIONS

(75) Inventor: Shobha Shakher Puntambekar, Morganville, NJ (US)

(73) Assignee: Illinois Tool Works Inc., Glenview, IL (US)

(21) Appl. No.: 13/283,270

(22) Filed: Oct. 27, 2011

Related U.S. Application Data
(60) Provisional application No. 61/407,208, filed on Oct. 27, 2010.

(51) Int. Cl. G01N 31/22; B32B 23/08; B32B 15/082; B32B 27/30

(52) U.S. Cl. 422/400; 436/7

(57) ABSTRACT

A temperature indicating composition, which undergoes an irreversible color change upon exposure to a predetermined heat history is provided. The temperature indicating composition includes a vinyl phenol resin and an electron donating compound.

### CROSS-REFERENCE TO RELATED APPLICATION DATA

This application claims the benefit of priority of Provisional U.S. Patent Application Ser. No. 61/407,208, filed Oct. 27, 2010, the disclosure of which is incorporated herein by reference.

### BACKGROUND

The present invention relates to temperature indicating compositions that produce a visible and permanent color change upon exposure to a predetermined heat history. The invention also relates to indicator materials containing coatings of the temperature indicating compositions on at least one surface of a suitable support.

Temperature indicating compositions and coatings which do not undergo a color change until they are exposed to a predetermined heat history are known. Some of these compositions are formulated with metallic salts such as carbonates of copper or lead, in which a sulfidic component reacts with the metallic salt to form a black metallic sulfide.

Color-changing reactions between an electron donating compound such as a prodye or chromogen and an electron accepting compound, typically a phenolic compound, have been known in the field of duplication and printing processes for the preparation of heat sensitive paper for thermal printing devices (see e.g. U.S. Pat. No. 4,289,535, U.S. Pat. No. 4,287,264, and U.S. Pat. No. 4,228,222.)

However, such compositions combining an electron donating prodye or chromogen compound with an electron accepting phenolic compound suffer from a tendency to undergo premature color change which is attributable to a lack of environmental stability, particularly to heat and moisture. Thus, unthermostated shipping and warehouse storage conditions, as well as tropical climates often cause undesired premature color changes.

U.S. Pat. No. 5,340,537, which is assigned to the assignee of the present application and incorporated herein by reference in its entirety, discloses temperature indicating compositions including phenolic polymeric electron accepting resins having a T_{g} and non-volatility effective to prevent premature color change. Condensation phenolic polymer resins, such as Resin HG, which is a polymer of Bisphenol A, and meta-cresol novolac resins, were disclosed as suitable electron accepting resins. However, these condensation phenolic polymers are often unstable, and exhibit inconsistent T_{g}, molecular weight and structures. For example, Resin HG is unstable during storage and production. In some production environments, Resin HG becomes highly viscous within few days, such that it cannot be used to make temperature indicating compositions. Such instability and inconsistency of the phenolic resins have presented quality problems for the temperature indication compositions and increased production cost.

Thus, there is a need for an improved temperature indicating composition, which includes a more stable and consistent electron accepting resin.

### BRIEF SUMMARY

Temperature indicating compositions including an electron accepting vinyl phenol resin and an electron donating compound are provided according to various embodiments of the present invention. The temperature indicating composition including the vinyl phenol polymer provides improved quality and stability when compared to temperature indicating compositions including the condensation polymer type phenolic resins. The vinyl phenol polymer, such as a homo-polymer of para-vinyl phenol, has a higher but more predictable molecular weight than the condensation type phenolic resins. Further, it provides increased reactivity and stability when compared to the condensation type phenolic resins, which enables production of a more stable temperature indicating composition that provides a predictable and repeatable color change upon exposure to a predetermined heat history.

In one aspect, a temperature indicating composition is provided. The temperature indicating composition includes a vinyl phenol component and a color changing compound. The vinyl phenol component reacts with the color changing compound upon exposure to a predetermined heat history.

In another aspect, a temperature indicator is provided. The temperature indicator includes a substrate and a temperature indicating composition. The temperature indicating composition includes an aqueous dispersion of an electron donating component, and an aqueous dispersion of an electron accepting component, which includes a vinyl phenol resin. The electron donating component reacts with the electron accepting component upon exposure to a predetermined heat history. In one embodiment, the aqueous dispersion of an electron donating component and the aqueous dispersion of an electron accepting component are mixed together to form the temperature indicating composition and coated on a surface of the substrate. Alternatively, the aqueous dispersion of an electron donating component and the aqueous dispersion of an electron accepting component are applied on a surface of the substrate as a separate coating layers. The substrate can be formed of a polymeric material, a cellulosic material, a metal foil, or a laminate thereof

The temperature indicating composition is stable upon exposure to dry heat at 284° F. for 30 minutes, yet undergoes an irreversible color change when exposed to saturated steam at 250° F. for 10 minutes at 15 psi.

In one embodiment, the temperature the vinyl phenol is a polyvinyl phenol, which is a homo-polymer of a para-vinyl phenol, and the color changing compound or the electron donating component is a leuco dye. The vinyl phenol preferably has a glass transition temperature (T_{g}) greater than 270° F. In other embodiments, the color changing compound or the electron donating component is a prodye or a chromogen compound. The temperature indicating composition preferably includes a stoichimetric excess of the vinyl phenol component.

In an embodiment, the temperature indicating composition includes an aqueous binder, which includes a polymer selected from the group consisting of starch, polyvinyl alcohol, styrenebutadiene rubber and certain acrylics. Preferably, the vinyl phenol is non-encapsulated, and the color changing compound or the electron donating component is non-encapsulated.

These and other features and advantages of the present invention will be apparent from the following detailed description, in conjunction with the appended claims.

### DETAILED DESCRIPTION

While the present disclosure is susceptible of embodiment in various forms, presently preferred embodiments are described herein with the understanding that the present disclosure is to be considered an exemplification of the disclosed compositions and is not intended to limit the compositions to the specific embodiment illustrated.

Temperature indicating compositions, which utilize a polymeric electron accepting resin of vinyl phenol, which has a T_{g} and non-volatility effective to prevent premature color change, are provided according to various embodiments. The vinyl phenol can be dispersed in aqueous binders with electron donating compounds that change color upon electron donation. The vinyl phenol can then be formed into coatings that do not change color until the coating has been exposed to a predetermined heat history. The electron donating compound is typically a prodye or chromogen that may be colorless to start with and develop a color upon reacting with the vinyl phenol, or the chromogen may be colored to start with and become colorless as the reaction is completed, or it may be a light color and change to a deep or other distinctive color. Once the predetermined threshold exposure conditions are met, the electron donating chromogen is oxidized by the vinyl phenol to develop the full color change. The electron donating chromogen and vinyl phenol resin are dispersed in an aqueous binder.

Aqueous binders for coating compositions such as paints or inks are essentially conventional and well-known to those of ordinary skill in the art. In general, the binders are aqueous polymer suspension or solutions selected to maintain the integrity of the composition coating on selected substrates. Suitable polymers include starch, polyvinyl alcohol, styrenebutadiene rubber and certain acrylics.

The vinyl phenol produces a visible and permanent color change in a coating of the temperature indicator composition upon exposure of the coating to a predetermined heat history. For dry environments, a vinyl phenol is selected having a T_{g} at or above the temperature to be recorded. For sterilization environments, including saturated steam or chemical sterilization agents, electron transfer between the vinyl phenol and electron donating compound will occur somewhat below the T_{g} of the vinyl phenol resin. Accordingly, a vinyl phenol should be selected having a T_{g} greater than the temperature condition to be recorded. If a combination of temperature and time is desired, that is, if the color change is to indicate that a predetermined temperature was attained and held for a predetermined time period, then an even higher T_{g} vinyl phenol should be employed.

The vinyl phenol resin is non-volatile. That is, at below-sterilization temperatures, the polymer does not produce vapors that will react with the electron donating compound to produce a premature color change.

The type of electron donating compound will vary depending upon the color desired for the temperature indicator composition, either before or after the color change. Likewise, the amount of vinyl phenol resin, as well as the amount of the electron donating compound, will vary largely depending upon the type of compounds which are used and are the desired shade and intensity of color to be produced in the temperature indicator coatings.

Any of various known chromogenic materials may be used for the electron donating compound, provided the chromogenic material has a melting point greater than 300° F.

An important feature of the temperature indicating compositions according to the present embodiments is that neither the vinyl phenol resin or the prodye or chromogen electron donating compound require encapsulation in microcapsules. That is, both the vinyl phenol resin and the electron donating compound are non-encapsulated. Compositions prepared in accordance with the present embodiments nevertheless will not undergo a color change until the predetermined heat history has been met. The compositions will also not undergo a change in color in the presence of formaldehyde or alcohol unless the desired heat history has been met. By not encapsulating either the electron donating compound or vinyl phenol resin, an improvement in product cost and an improvement in production efficiency is obtained.

Although, the ratio of the vinyl phenol resin and electron donating compound in the temperature indicating composition is not critical, a stoichiometric excess of vinyl phenol resin is preferred to promote the release of electrons from the electron donating compound, and consequently, to promote the color change once the predetermined heat history has been met. The molecular structure of the vinyl phenol resin, such as polyvinyl phenol which is a homopolymer of para-vinyl phenol, can be clearly identified. Thus, the ratio of the vinyl phenol resin and the electron donating compound can be easily formulated according to different applications. This is another advantage of using the vinyl phenol resin rather than the condensation type phenolic resins. The structure and number of —OH group in the condensation type phenolic resins are inconsistent and difficult to determine. Thus, formulating and making a temperature indicating composition that gives a predictable and repeatable color change upon exposure to a predetermined heat history is much more difficult with the condensation type phenolic resins than the vinyl phenol resin.

A color change can be produced at temperatures below the effective dry heat signaling temperature of the compositions by including in the compositions an additive inert to the electron transfer reaction between the electron donating compound and vinyl phenol resin and having a melting point slightly below the lower color signaling temperature.

Essentially any crystalline material inert to the electron transfer reaction, having the requisite melting point and capable of forming a medium in which both the electron donating and vinyl phenol compounds are soluble is suitable for use as the inert additive. While not being bound by any particular theory, it is believed that the additive, at or about its melting point, provides a medium through which the electron transfer can occur.

The temperature indicating compositions according to the present embodiments also include various conventional additives for paint and ink-type coating compositions. For example, pigments such as titanium dioxide are selected to provide hiding power and color enhancement of the signal color. Also among the additives are coloring dyes, which do not change color upon exposure to the predetermined heat history. This permits the modification of the color change. For example, a blue coloring dye can be combined with a chromogen that changes from colorless to red upon electron donation to effect a color change from blue to purple. The selection of dispersion-improving pigments and coloring dyes is essentially conventional and well-understood by those of ordinary skill in the art.

Other additives suitable for use with the compositions include surfactants, releasing agents, carriers, lubricants, extenders, biocides, drying agents, dispersing agents, defoamers, rheology and viscosity modifiers, and the like.

A temperature indicating composition according to an embodiment is prepared by separately forming aqueous dispersions of the vinyl phenol resin and the prodye or chromogen electron donating compound. The vinyl phenol resin dispersion contains the vinyl phenol resin, a portion of the water-soluble binder polymer and a portion of any titanium dioxide or other dispersing agent to be utilized. The electron donating compound dispersion contains the prodye or chromogen electron donating compound, the remainder of the water-soluble binder polymer and the remainder of the titanium dioxide or other dispersing agent, if present, as well as any other conventional additive to be utilized. Both dispersions are each separately ground with water sufficiently to reduce the solids to an average particle size of several microns.

The resulting two dispersions are then mixed together, preferably without heat, into a single temperature indicating coating composition, which may be applied to a suitable support, optionally after being further diluted with an aqueous diluents, compatible with the bulk formulation. Alternatively, the two dispersions may be applied to the support separately to form different layers of coating.

The temperature indicating composition may be coated onto one or more surfaces of various support substrates by conventional coating processes to obtain tape-type, label-type and card-type temperature monitoring articles, such as sterilization monitoring articles. These articles can be coated with an adhesive to adhere them to various substrates. The compositions can also be printed or coated directly onto packages, boxes, cartons, containers and the like to monitor the heat-history of the contents.

Preferred substrates for receiving coatings of the temperature indicating compositions, which may be either formed into a tape, label or card that is adhesively applied to a second substrate, or formed into a package, box, carton, container or the like bearing a temperature indicating coating, include polymeric materials, cellulosic materials, metal foils and laminates thereof. Thus, the temperature indicating compositions may be applied to a substrate support such as a carrier, film, web or the like by any number of conventional coating processes known to the art including extrusion coating, printing, and the like. Suitable printing processes include metered doctor roll coating, gravure, flexographic, lithographic, reverse roll coating, slot dye coating, silkscreening, decalcomania, and the like.

The coating may be air dried or the water present may be driven off after application of the coating by conventional oven drying processes.

The temperature indicating composition may be applied in a pattern of varying shapes to draw attention to the indicator coating. The powder may also be in the form of a message such as “sterile” that appears upon exposure to the heat history.

### EXAMPLE

A temperature indicating composition is formulated according to an embodiment. The temperature indicating composition includes a leuco dye and a polyvinyl phenol. A reaction between the electron donating leuco dye and the electron accepting polyvinyl phenol is shown below.

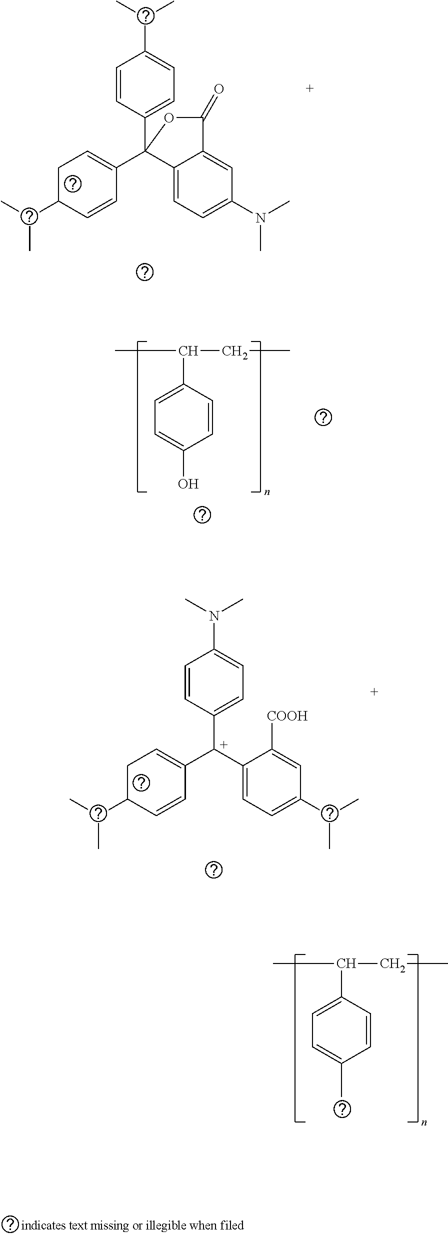

In this example, the spiro form of an oxazine, which is a colorless leuco dye, is used. In the spiro form of leuco dye, a conjugated system of the oxazine and another aromatic part of the molecule is separated by a sp³-hybridized spiro carbon. After protonating a part of the molecule, the bond between the spiro carbon and the oxazine interrupts, and the ring opens, and the spiro carbon achieves sp² hybridization and becomes planar. Then the aromatic group rotates and aligns its π-orbitals with the rest of the molecule, and the conjugated system forms with ability to absorb photons of visible light, which therefor appears colorful.

The polyvinyl phenol used in this example is a homopolymer of para-vinyl phenol marketed as Maruka Lyncur® by Chemiway Maruzen Petrochemical Co., Ltd., Tokyo, Japan. The polyvinyl phenol has a higher molecular weight than condensation type phenolic resins of a similar structure. Further, the polyvinyl phenol provides an improved reactivity and stability when compared to the condensation type phenolic resins, such as Resin HG. Further, since the structure of the polyvinyl phenol is clearly identifiable, its reaction can be predicted and a molecular weight of the polymer can be selected according to applications. On the other hand, the structure of the condensation type phenolic resins is difficult to identify, and thus, the number of —OH group available for a reaction with the electron donating compound is difficult to determine. As such, the reaction is often unpredictable, and production of a temperature indicating composition, which can provide a consistent, predictable, and repeatable color change, is difficult.

All patents referred to herein, are hereby incorporated herein by reference, whether or not specifically do so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A temperature indicating composition, comprising:
a vinyl phenol component; and
a color changing compound, wherein the vinyl phenol component reacts with the color changing compound upon exposure to a predetermined heat history.

2. The temperature indicating composition of claim 1, wherein the vinyl phenol component is a polyvinyl phenol, which is a homo-polymer of a para-vinyl phenol.

3. The temperature indicating composition of claim 1, wherein the color changing compound is a spiro form of a leuco dye.

4. The temperature indicating composition of claim 1, wherein the temperature indicating composition is stable upon exposure to dry heat at 284° F. for 30 minutes and undergoes an irreversible color change when exposed to saturated steam at 250° F. for 10 minutes at 15 psi.

5. The temperature indicating composition of claim 1, wherein the vinyl phenol component has a glass transition temperature (T_{g}) greater than 270° F.

6. The temperature indicating composition of claim 1, wherein the color changing compound is a prodye or a chromogen electron donating compound.

7. The temperature indicating composition of claim 1, wherein the temperature indicating composition includes a stoichimetric excess of the vinyl phenol component.

8. The temperature indicating composition of claim 1, further comprising an aqueous binder.

9. The temperature indicating composition of claim 8, wherein the aqueous binder is an aqueous polymer suspension including a polymer selected from the group consisting of starch, polyvinyl alcohol, styrenebutadiene rubber and certain acrylics.

10. The temperature indicating composition of claim 1, wherein the vinyl phenol component is non-encapsulated.

11. The temperature indicating composition of claim 1, wherein the color changing compound is non-encapsulated.

12. A temperature indicator, comprising a substrate and a temperature indicating composition, the temperature indicating composition comprising:
an aqueous dispersion of an electron donating component; and
an aqueous dispersion of an electron accepting component, the electron accepting component including a vinyl phenol resin,
wherein the electron donating component reacts with the electron accepting component upon exposure to a predetermined heat history.

13. The temperature indicator of claim 12, wherein the aqueous dispersion of an electron donating component and the aqueous dispersion of an electron accepting component are mixed together to form the temperature indicating composition, wherein the temperature indicating composition is coated on a surface of the substrate.

14. The temperature indicator of claim 12, wherein the aqueous dispersion of an electron donating component and the aqueous dispersion of an electron accepting component are applied on a surface of the substrate as a separate coating layers.

15. The temperature indicator of claim 12, wherein the substrate comprises a material selected from the group consisting of polymeric material, cellulosic material, metal foils, and laminates thereof.

16. The temperature indicator of claim 12, wherein the electron accepting component is a polyvinyl phenol, and the electron donating component is a leuco dye.

17. The temperature indicator of claim 12, wherein the temperature indicating composition is stable upon exposure to dry heat at 284° F. for 30 minutes and undergoes an irreversible color change when exposed to saturated steam at 250° F. for 10 minutes at 15 psi.

18. The temperature indicator of claim 12, wherein the aqueous dispersion of an electron donating component includes a water-soluble binder including a polymer selected from the group consisting of starch, polyvinyl alcohol, styrenebutadiene rubber and certain acrylics, and the aqueous dispersion of an electron accepting component includes a water-soluble binder including a polymer selected from the group consisting of starch, polyvinyl alcohol, styrenebutadiene rubber and certain acrylics.

19. The temperature indicator of claim 12, wherein the electron donating component is non-encapsulated, and the electron accepting component is non-encapsulated.

20. The temperature indicator of claim 12, wherein the electron donating component is a prodye or a chromogen compound.
